(19) United States
(12) Patent Application Publication
(10) Pub. No.: US 2015/0206373 A1
(43) Pub. Date: Jul. 23, 2015

(54) BEVERAGE VENDING MACHINE AND METHOD FOR CONTROLLING TEMPERATURE OF VENDING MACHINE

(71) Applicants: Tai Ho Kim, Seoul (KR); Byung Suhn Ahn, Seoul (KR)

(72) Inventors: Tai Ho Kim, Seoul (KR); Byung Suhn Ahn, Seoul (KR)

(73) Assignees: SUPERCOOLER, INC., Incheon (KR); SUPER COOLER USA, INC., New York, NY (US)

(21) Appl. No.: 14/420,687

(22) PCT Filed: Aug. 24, 2012
(86) PCT No.: PCT/KR2012/006770

§ 371 Date: Feb. 10, 2015

(51) Int. Cl. G07F 9/10; G07F 11/16

(52) U.S. Cl. CPC G07F 9/105; G07F 11/165

(57) ABSTRACT

In order to stably provide customers with beverages in a supercooled state without impact, the present invention provides a vending machine which sells beverages, the vending machine including: a main body which has a storage chamber that accommodates beverages and stores the beverages in a supercooled state; racks which are disposed in the storage chamber and on which the beverages are placed; a cooling unit which cools air in the storage chamber; a cool air supplying unit which circulates air cooled by the cooling unit into the storage chamber; a cool air controlling unit which controls a temperature of cool air supplied from the cool air supplying unit in a supercooled temperature range of the canned beverage; and a dispensing unit which withdraws the beverage placed on the rack while keeping the beverage supercooled, and moves the beverage to an outlet of the main body.

### BACKGROUND OF THE INVENTION

(a) Field of the Invention

The present invention relates to a vending machine for automatically selling beverages such as canned beverages. More particularly, the present invention relates to a beverage vending machine which is capable of cooling beverage and selling the beverage in a supercooled state, and a method of controlling temperature of the vending machine.

(b) Description of the Related Art

In general, a vending machine is an apparatus that sells products in an unmanned manner, and provides the product stored therein when a user pays for the product with coins, paper money, or a credit card. The vending machine may sell various products such as beverages, cigarettes, food, books, and lottery tickets, and is mainly used to sell beverages including canned beverages.

The vending machine has a storage chamber which is disposed in a main body and accommodates the beverages, and a cooling device which cools the beverages accommodated in the storage chamber. At the front side of the main body, a coin slot through which coins are inserted, an operating unit which is used to select the beverage, and an outlet through which the beverages are dispensed are installed. Further, a chute is connected between the outlet of the main body and the storage chamber, and a variety of devices are equipped in order to selectively dispense the beverages through the chute. The cooling device supplies cool air into the storage chamber, thereby keeping the stored beverages cold.

Therefore, when the user inserts coins into the coin slot and then selects the beverage, the corresponding beverage stored in the storage chamber is dispensed to the outlet through the chute. However, this beverage vending machine in the related art merely provides the beverage in a cooled state.

When the liquid beverage is supercooled below a freezing point, the beverage is frozen in a slurry state. A freezer or the like, which provides a liquid in a slurry state created by this phenomenon, is being developed. The term “supercooling” means a phenomenon in which, although a melted object or a solid object is cooled up to a phase-transition temperature or lower in a balance state, the melted object or solid object is not changed. Since a material has a stable state depending on the temperature at the time, when the temperature is gradually changed, constituent atoms of the material may correspondingly follow a change in temperature while maintaining the stable state at each temperature. However, when the temperature is unexpectedly changed, since the constituent atoms have no time to change into the stable state depending on each temperature, the constituent atoms just maintain a stable state at a start-point temperature or some of the constituent atoms stop changing to a state at an end-point temperature.

For example, when water is gradually cooled, the water is not temporarily solidified even though the temperature of the water becomes a temperature of 0° C. or lower. However, when an object is supercooled, the object enters a kind of semi-stable state but is not frozen, and an instable balance state is broken even by minor stimulation, and as a result, the state of the object is easily transited to a more stable state. That is, when small pieces of the material are input in a supercooled liquid or the liquid is unexpectedly shaken, the liquid starts to become solidified immediately, and as a result, the temperature of the liquid increases up to a solid point and the liquid maintains the stable balance state at that temperature.

A temperature condition should be adjusted well and the adjusted temperature condition should be stably maintained in order to supercool the liquid beverages. However, it is very difficult to control a temperature in accordance with the supercooled temperature condition of the beverage, and uniformly maintain temperature distribution.

Moreover, since the vending machine in the related art merely provides beverages in a cooled state, it is required to develop a vending machine which keeps beverages supercooled and provides the beverages in a slurry state.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a beverage vending machine which is capable of cooling beverages and providing the beverages in a supercooled state, and a method of controlling a temperature of the vending machine.

The present invention has also been made in an effort to provide a beverage vending machine which is capable of uniformly and stably maintaining a temperature in a storage chamber which accommodates beverages, in accordance with a supercooled temperature of the beverages, and a method of controlling a temperature of the vending machine.

The present invention has also been made in an effort to provide a beverage vending machine which is capable of stably providing customers with beverages in a supercooled state without impact, and a method of controlling a temperature of the vending machine.

An exemplary embodiment of the present invention provides a vending machine which sells beverages, the vending machine including: a main body which has a storage chamber that accommodates beverages and stores the beverages in a supercooled state; racks which are disposed in the storage chamber and on which the beverages are placed; a cooling unit which cools air in the storage chamber; a cool air supplying unit which circulates air cooled by the cooling unit into the storage chamber; a cool air controlling unit which controls a temperature of cool air supplied from the cool air supplying unit in a supercooled temperature range of the canned beverage; and a dispensing unit which withdraws the beverage placed on the rack while keeping the beverage supercooled, and moves the beverage to an outlet of the main body.

The cooling unit may include: an evaporator which is installed at a lower end of the main body and cools air using heat exchange; a cooling duct in which the evaporator is installed and which connects the interior of the storage chamber with the cool air supplying unit; a suction blower which is installed at one side of the cooling duct and suctions air in the storage chamber; and a compressor and a condenser which circulate a refrigerant into the evaporator.

The cool air supplying unit may include: a supply duct which extends upward along an inner surface of the storage chamber; a supply blower which is installed at a lower end of the supply duct connected with the cooling duct, and sends the cool air to the supply duct; and a plurality of holes which are formed in a front surface of the supply duct, and discharge the cool air.

The cool air controlling unit may include: a mixing unit which supplies the air in the storage chamber to the cool air supplying unit and mixes the supplied air with cool air as necessary; a temperature sensor which is installed in the supply duct and detects a temperature at the storage chamber; and a controller which calculates values detected by the temperature sensor and controls the cooling unit, the cool air supplying unit, and the mixing unit so that the temperature in the storage chamber is in a predetermined temperature range.

The mixing unit may include a mixing blower which is installed between the lower end of the supply duct and the storage chamber, and sends the air in the storage chamber to the supply duct.

The mixing unit may have a structure in which the lower end of the supply duct is installed to simultaneously face the storage chamber and the cooling duct, and the supply blower is installed to simultaneously face the storage chamber and the cooling duct such that the cool air in the cooling duct and the air in the storage chamber are sent into the supply duct.

The holes may be formed so that the number of formed holes or the sizes of the holes are increased in a direction from the lower side to the upper side of the storage chamber.

The cool air controlling unit may further include a sensor which detects an opened or closed state of a front window installed at the front side of the main body, and the controller may stop the operations of the cooling unit, the cool air supplying unit, and the mixing unit at the time of opening the front window in response to output values from the sensor.

The cool air controlling unit may further include a heater which is installed in the supply duct and heats the cool air, and the controller may control the heater so that the temperature in the storage chamber is in a predetermined temperature range.

The cool air controlling unit may further include one or more heat pipes that extend vertically in the supply duct and are disposed at predetermined intervals.

The present vending machine may have a structure in which the temperature in the storage chamber is adjusted to be in a range from −3° C. to −15° C.

The racks may include: a plurality of shelves which are installed in the storage chamber at predetermined intervals in a vertical direction; and moving units which are installed on the shelves and move the beverages forward.

The moving unit may include: a conveyor belt which is installed on the bottom surface of the shelf in the forward and rearward directions and on which the beverages are placed; and a drive motor which is connected to a driving roller of the conveyor belt and rotates the conveyor belt.

Partition walls, which separate the beverages in a lateral direction, may be installed on the shelves at predetermined intervals, and the moving unit may be installed between the partition walls.

A detecting sensor, which detects whether the beverage is present or not, may be further installed at a tip of the partition wall.

The dispensing unit may include: a lifting member which is installed between the front window of the main body and the shelves so as to be vertically moved; an up-and-down drive unit which moves the lifting member upward and downward; a clamp which is installed on the lifting member and clamps the beverage placed on the shelf; a rotating unit which rotates the clamp; and a left-and-right drive unit which moves the clamp to the left and right sides of the main body along the lifting member.

The clamp may include: a pair of clamping bars which are elongated and hold the beverage; a drive block which has both lateral sides at which the clamping bars are installed, and operates the clamping bars; a base member which is coupled to the rotating unit and has an upper end at which the drive block is movably installed; and a drive unit which moves the drive block relative to the base member.

The up-and-down drive unit may include: guide rails which are installed on the main body in the vertical direction; guide bars which are installed on the lifting member, coupled to the guide rails, and moved along the guide rails; sprocket wheels which are installed at the upper and lower sides of the main body; a chain which is fastened to the sprocket wheels and has a tip connected to the lifting member; and a drive motor which operates the sprocket wheel.

The left-and-right drive unit may include: a pair of rollers which are installed at both lateral ends of the lifting member; a conveyor belt which is rotated while being connected with the rollers and on which the rotating unit is installed; and an operating motor which rotates the rollers.

The dispensing unit may further include: a dispensing box which is formed in the outlet and has a horizontal bottom surface on which the beverage is placed; an outlet door which opens and closes the outlet; an inlet which is formed at a side surface inside the dispensing box and allows the beverage held by the clamping bars to enter the inlet; and a blocking shutter which is installed at the inlet and selectively blocks the inlet.

The dispensing unit may further include an air fan which is installed above the blocking shutter and forms an air curtain by discharging air downward.

Another exemplary embodiment of the present invention provides a method of controlling a temperature of a vending machine which stores beverages in a supercooled state in a storage chamber, the method including: detecting a temperature in the storage chamber of the vending machine; comparing the detected temperature value with an upper-limit value within a predetermined first temperature range; supplying cool air into the storage chamber when the detected temperature value is equal to or higher than the upper-limit value within the first temperature range; comparing the detected temperature value with an upper-limit value within a second temperature range when the detected temperature value is lower than the upper-limit value within the first temperature range; controlling a temperature of cool air supplied into the storage chamber when the detected temperature value is lower than the upper-limit value within the second temperature range; stopping the controlling of the temperature of the cool air when the temperature in the storage chamber is detected and the detected temperature value is equal to or lower than a lower-limit value within the second temperature range; comparing the detected temperature value with a lower-limit value within the first temperature range; stopping the supplying of the cool air when the detected temperature value is equal to or lower than the lower-limit value within the first temperature range; and consistently stopping the supplying of the cool air when the temperature in the storage chamber is detected and the detected temperature is lower than the upper-limit value within the first temperature range, and supplying the cool air into the storage chamber when the detected temperature is equal to or higher than the upper-limit value within the first temperature range.

The second temperature range may be within the first temperature range.

The controlling of the temperature of the cool air may include mixing the air in the storage chamber with the cool air supplied to the storage chamber.

The controlling of the temperature of the cool air may include controlling a ratio between a supply amount of cool air supplied to the storage chamber and a supply amount of air in the storage chamber which is mixed with the cool air.

The controlling of the temperature of the cool air may include controlling a heater installed on a supply duct through which the cool air is supplied.

The method of controlling the temperature may further include adjusting the first temperature range in accordance with the type of beverages stored in the storage chamber of the vending machine, in which the adjusting of the first temperature range includes manipulating buttons that are classified by the type of beverages.

According to the present exemplary embodiment, it is possible to sell the beverage maintained in a supercooled state using the vending machine.

In addition, temperatures of the beverages in the vending machine may be uniformly and stably maintained to a supercooled temperature.

Further, it is possible to stably provide customers with the selected beverage without external impact while consistently keeping the beverage supercooled.

### BRIEF DESCRIPTION OF THE DRAWINGS

FIG. 1 is a schematic front view illustrating a beverage vending machine according to the present exemplary embodiment.

FIG. 2 is a schematic cross-sectional side view illustrating the beverage vending machine according to the present exemplary embodiment.

FIG. 3 is a schematic block diagram illustrating a structure for controlling the beverage vending machine according to the present exemplary embodiment.

FIGS. 4 and 5 are a top plan view and a front view illustrating a structure of a dispensing unit of the beverage vending machine according to the present exemplary embodiment.

FIGS. 6 and 7 are schematic views for explaining an operation of the dispensing unit of the beverage vending machine according to the present exemplary embodiment.

FIG. 8 is a schematic cross-sectional side view illustrating a beverage vending machine according to another exemplary embodiment.

FIG. 9 is a schematic flowchart illustrating a method of controlling the beverage vending machine according to the present exemplary embodiment.

### DETAILED DESCRIPTION OF THE EMBODIMENTS

Hereinafter, exemplary embodiments of the present invention will be described with reference to the accompanying drawings so that those skilled in the technical field to which the present invention pertains may easily carry out the exemplary embodiment. It can be easily understood by those skilled in the art to which the present invention pertains that the following exemplary embodiments may be modified to various forms without departing from the concept and the scope of the present invention. In the drawings, like reference numerals refer to like or similar parts as much as possible.

The technical terms used herein are merely for the purpose of describing a specific exemplary embodiment, and not intended to limit the present invention. Singular expressions used herein include plural expressions unless they have definitely opposite meanings. The terms “comprises” and/or “comprising” used in the specification specify particular features, regions, integers, steps, operations, elements, and components, but do not preclude the presence or addition of other particular features, regions integers, steps, operations, elements, components, and/or groups thereof.

All terms used herein including technical or scientific terms have the same meanings as meanings which are generally understood by those skilled in the art. Terms defined in advance shall be construed such that they have meanings matching those in the context of a related art, and shall not be construed in ideal or excessively formal meanings unless they are clearly defined in the present application.

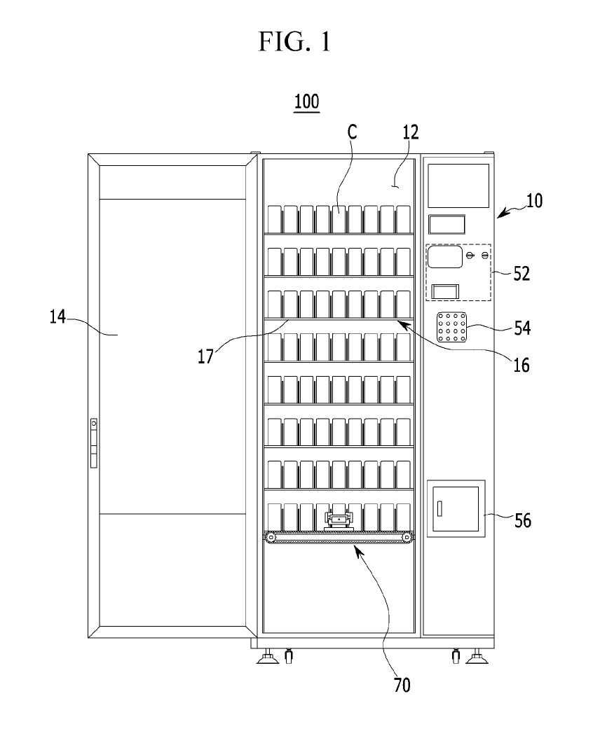

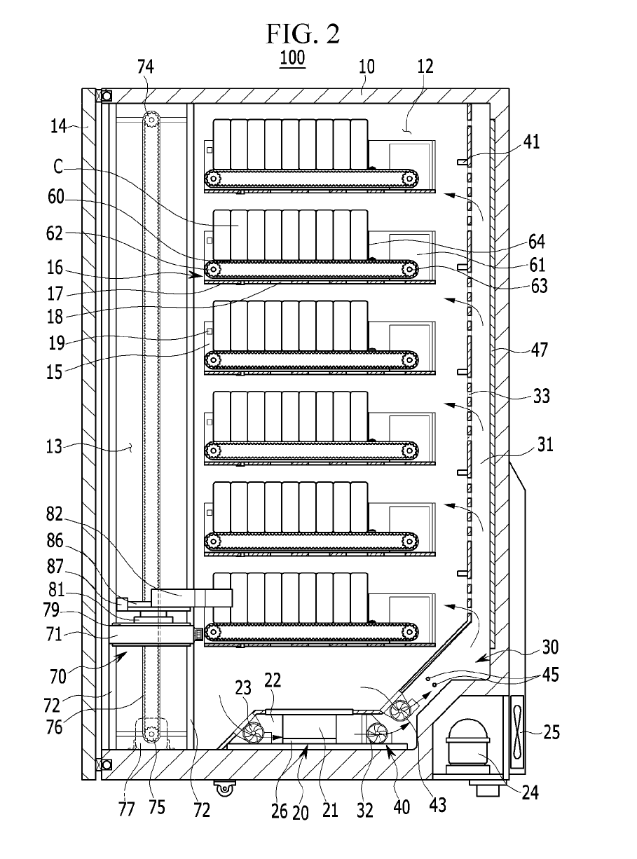

FIG. 1 is a front view of a beverage vending machine according to the present exemplary embodiment, and FIG. 2 is a cross-sectional side view of the beverage vending machine according to the present exemplary embodiment.

Hereinafter, in the present exemplary embodiment, a vending machine 100 used to sell canned beverages C will be described as an example. However, the present vending machine 100 is not limited thereto, and may be used to sell all beverages contained in bottles or packs as well as the canned beverages.

As illustrated in FIG. 1, the vending machine 100 according to the present exemplary embodiment includes a main body 10 which has a storage chamber 12 that accommodates the canned beverages C, racks 16 which are disposed in the storage chamber and on which the beverages are placed, a cooling device which supercools the canned beverages, and a dispensing unit 70 which dispenses the canned beverage C placed on the rack while keeping the canned beverage C supercooled.

The main body 10 is formed as a quadrangular heat insulated structure that has an opened front side and the other side closed. A front window 14 having a heat insulated structure is rotatably installed at the front side of the main body 10, shields the storage chamber in the main body from the outside, and is opened and closed as necessary. The front window 14 may be made of a transparent material so that customers can see the canned beverages C stored on the racks in the storage chamber from the outside. The interior of the main body 10 defines the storage chamber 12 that is a space in which the canned beverages are accommodated and then supercooled.

The vending machine 100 supercools the canned beverage C stored on the racks or keeps the canned beverage C supercooled using an operation of the cooling device.

To this end, as illustrated in FIG. 2, the cooling device provided in the vending machine 100 includes a cooling unit 20 which cools air in the storage chamber 12, a cool air supplying unit 30 which circulates air cooled by the cooling unit 20 into the storage chamber 12, and a cool air controlling unit 40 which controls a temperature of the cool air supplied from the cool air supplying unit 30 in a supercooled temperature range of the canned beverage C.

A temperature in the storage chamber 12 is controlled based on a supercooled condition of the canned beverage C, and is maintained in a range of approximately −3° C. to −15° C.

The cooling unit 20 serves to decrease the temperature in the storage chamber 12, and includes an evaporator 21 which is installed at a lower end of the main body 10 and cools air, a cooling duct 22 in which the evaporator 21 is installed and which connects the interior of the storage chamber 12 with the cool air supplying unit 30, and a suction blower 23 which is installed at one side of the cooling duct 22 and suctions air in the storage chamber 12.

In the present exemplary embodiment, the cooling duct 22 is disposed at a bottom side of the storage chamber 12. The cooling duct 22 has an inlet through which air in the storage chamber 12 is suctioned, and an outlet through which the cool air is discharged to the outside. The evaporator 21 for cooling air in the storage chamber 12 is installed in the cooling duct 22. Therefore, air which flows into the cooling duct 22 through the inlet is cooled while passing through the evaporator 21, and then discharged as cool air through the outlet. The inlet of the cooling duct 22 is disposed at a front side of storage chamber 12 at which the front window 14 is installed. The outlet of the cooling duct 22 is disposed at the inside of the storage chamber 12, which is an opposite side to the inlet. The suction blower 23 is installed in the inlet of the cooling duct 22. The suction blower 23 has an elongated cylindrical fan, a suction port through which air is suctioned is formed at one side of the suction blower 23, and a discharge port through which air is discharged is formed at the other side of the suction blower 23.

The suction blower 23 is disposed so that the suction port is directed toward the interior of the storage chamber 12, and the discharge port is directed toward the interior of the cooling duct 22. The suction blower 23 allows air in the storage chamber 12 to be suctioned into the cooling duct 22. In the present exemplary embodiment, the suction blower 23 is used as a component that suctions air through the inlet of the cooling duct, and as a result, it is possible to prevent air flowing into the cooling duct and air flowing out of the cooling duct from being mixed with each other, and to accurately and constantly control and maintain the cool air. In addition, it is possible to increase an area in which air flows, precisely control an air flow rate while easily increasing and decreasing the air flow rate by adjusting a speed of the blower, and reduce noise caused by suctioning air.

The evaporator 21 cools surrounding air by using a cooling action in the cooling duct 22, which absorbs surrounding latent heat while evaporating a refrigerant. A compressor 24, which is connected with the evaporator 21 and compresses the refrigerant, and a condenser 25, which condenses the high-temperature and high-pressure refrigerant compressed by the compressor 24 by radiating heat from the refrigerant and transfers the condensed refrigerant to the evaporator 21, are installed at a lower side of the main body 10. As described above, the cooling unit including the compressor and the condenser is disposed at the lower side of the main body, and as a result, it is possible to further reduce vibration or noise, and increase stability. The cooling unit may also be disposed at an upper side of the main body in addition to the lower side of the main body.

The cool air supplying unit 30 is connected with the discharge port of the cooling duct 22, and supplies the cool air which is cooled while passing through the evaporator 21 into the storage chamber 12. To this end, the cool air supplying unit 30 includes a supply duct 31 which extends upward along an inner surface of the storage chamber 12, a supply blower 32 which is installed at a lower end of the supply duct 31 connected with the cooling duct 22 and sends the cool air to the supply duct 31, and a plurality of holes 33 which are formed in a front surface of the supply duct 31, and discharges the cool air.

In the present exemplary embodiment, the supply duct 31 is vertically installed on the inner surface of the storage chamber 12. The present invention is not limited to the configuration in which the supply duct 31 is installed on the inner surface of the storage chamber 12, and the supply ducts 31 may be installed on both lateral surfaces of the storage chamber 12, which face each other. The plurality of holes 33 for blowing the cool air into the storage chamber 12 are arranged in the front surface of the supply duct 31, that is, a surface directed toward the storage chamber 12.

As illustrated in FIG. 2, each of the holes 33 is formed at a position corresponding to a space disposed above each of the racks 16 which are vertically disposed. The holes 33 are formed so that when the canned beverages are placed on the racks 16, the cool air flows downward from the upper sides of the canned beverages, and then flows toward the entirety of the canned beverages. Alternatively, the holes 33 may be uniformly distributed between both lateral surfaces of the storage chamber 12, which are disposed in the width direction. In addition, the holes 33 are formed so that the number of formed holes 33 or the sizes of the holes 33 are increased in a direction from the lower side to the upper side of the storage chamber 12. Accordingly, the cool air, which is transferred through the supply duct 31 from the lower side to the upper side, may be discharged at a substantially constant flow rate through the holes 33 that are formed to correspond to the respective racks 16 in the vertical direction of the storage chamber 12.

The cool air is discharged into the storage chamber 12 through the holes 33, and supercools the canned beverages C placed on the respective racks 16 in the storage chamber 12. The cool air discharged into the storage chamber 12 flows around the canned beverages C, and then is suctioned into the cooling duct 22 through the inlet of the cooling duct 22 as described above.

The supply blower 32 is installed between the outlet of the cooling duct 22 and a lower end of the supply duct 31, and discharges the cool air, which is cooled while passing through the cooling duct 22, to the supply duct 31. The supply blower 32 has an elongated cylindrical fan, a suction port through which air is suctioned is formed at one side of the supply blower 32, and a discharge port through which air is discharged is formed at the other side of the supply blower 32. The supply blower 32 is disposed so that the suction port is directed toward the interior of the cooling duct 22, and the discharge port is directed toward the interior of the supply duct 31. The supply blower 32 transfers the cool air in the cooling duct to the supply duct 31. In the present exemplary embodiment, the supply blower 32 is used as a component that supplies the cool air to the supply duct 31, and as a result, it is possible to prevent the cool air or the air in the storage chamber from flowing in a reverse direction, and to accurately and constantly control and maintain a supply amount of air by adjusting a speed of the blower. In addition, it is possible to increase an area in which air flows, and reduce noise at the time of discharging the cool air.

In this case, the present vending machine mixes the air in the storage chamber 12 with the cool air using the cool air controlling unit 40 while supplying the cool air in the cooling duct 22 to the supply duct 31, and controls the temperature of the cool air so to be in the supercooled temperature range of the canned beverage C.

The cool air controlling unit 40 includes a mixing unit which supplies the air in the storage chamber 12 to the cool air supplying unit 30 and mixes the supplied air with the cool air as necessary, a temperature sensor 41 which is installed in the supply duct 31 and detects a temperature at the storage chamber 12, and a controller 42 which calculates values detected by the temperature sensor 41 and controls the cooling unit 20, the cool air supplying unit 30, and the mixing unit so that the temperature in the storage chamber 12 is in a predetermined temperature range.

In the present exemplary embodiment, the mixing unit includes a mixing blower 43 which is installed between the lower end of the supply duct 31 and the storage chamber 12, and sends the air in the storage chamber 12 to the supply duct 31.

As illustrated in FIG. 2, the size of the lower end of the supply duct 31 is sufficiently greater than the discharge port of the supply duct 31, and as a result, the lower end of the supply duct 31 extends upward over an upper end of the supply duct 31. Therefore, a part of the lower end of the supply duct 31 is in communication with the discharge port of the cooling duct 22, and the rest of the lower end of the supply duct 31 is in communication with the storage chamber 12 outside the supply duct. The mixing blower 43 is installed between the storage chamber 12 and the supply duct 31 to discharge the air in the storage chamber 12 into the supply duct 31.

The mixing blower 43 has an elongated cylindrical fan, a suction port through which air is suctioned is formed at one side of the mixing blower 43, and a discharge port through which air is discharged is formed at the other side of the mixing blower 43. The mixing blower 43 is disposed so that the suction port is directed toward the interior of the storage chamber 12, and the discharge port is directed toward the interior of the supply duct 31.

Therefore, the cool air, which is cooled while passing through the cooling duct 22, is discharged into the supply duct 31 by the supply blower 32, and a part of air in the storage chamber 12 is suctioned directly into the supply duct 31 by the mixing blower 43 without passing through the cooling duct 22. Therefore, the cool air passing through the evaporator 21 and the air in the storage chamber 12 are mixed in the supply duct 31, and the mixed cool air is supplied into the storage chamber 12 through the supply duct 31.

In the present exemplary embodiment, the cool air controlling unit 40 controls and operates the mixing blower 43 in accordance with the temperature in the storage chamber 12, and adjusts the temperature in the storage chamber 12.

The temperature sensor 41 is installed at one side of the supply duct 31, and detects the temperature in the storage chamber 12. The temperature sensor 41 may be installed at a position corresponding to each of the racks 16.

The controller 42 operates the compressor 24 in response to a detection result from the temperature sensor 41 and produces cool air using the evaporator 21, or controls an air flow rate of the mixing blower 43 or the supply blower 32, thereby adjusting the temperature in the storage chamber 12.

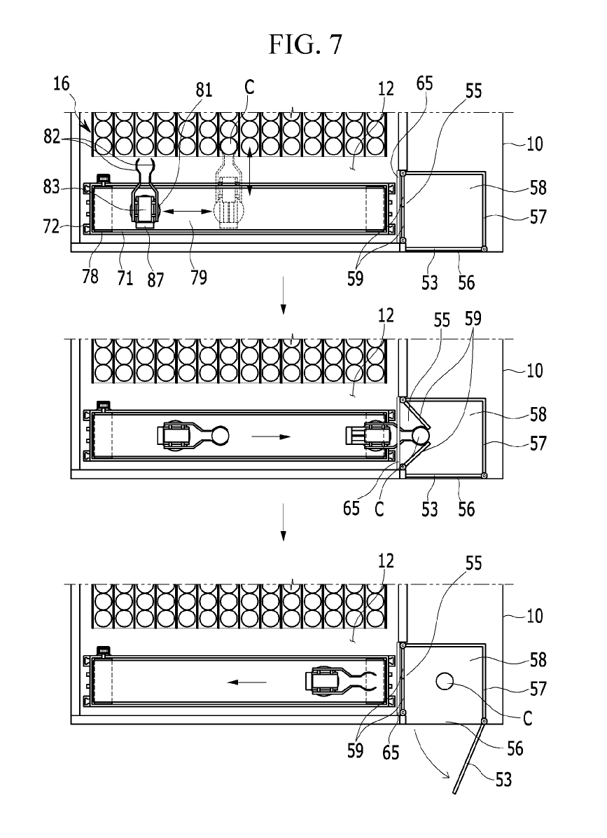

In addition, a sensor (see 44 in FIG. 7), which detects an opened or closed state of the front window 14, is installed at one side of the front window 14 or the main body 10. The controller 42 stops the operations of the cooling unit 20, the cool air supplying unit 30, and the mixing unit in response to output values from the sensor 44 at the time of opening the front window 14. That is, when the front window 14 is opened, the controller 42 forcibly stops the operations of the respective blowers and the compressor 24 in response to output signals from the door sensor 44.

In addition, the cool air controlling unit 40 may further include a heater 45 which is installed in the supply duct 31, and heats the cool air in order to control the temperature of the cool air. The heater 45 has a heating wire which converts electrical energy into thermal energy, and is installed inside the lower end of the supply duct 31.

When the heater 45 is operated, the temperature of the mixed cool air is increased, thereby preventing the temperature in the storage chamber 12 from being rapidly decreased, and properly controlling the cool air in accordance with the supercooled temperature range of stored goods. In addition, it is possible to control the temperature of the cool air, and remove frost created in the evaporator. A heater 26 may be further installed in the evaporator 21 in order to remove the frost.

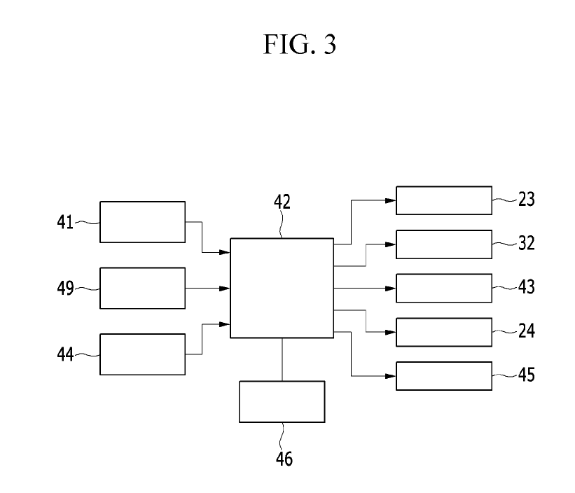

FIG. 3 illustrates a control structure for keeping the canned beverages which are stored in the present vending machine supercooled, using the controller.

In the present exemplary embodiment, the controller 42 of the cool air controlling unit 40 receives signals from the temperature sensor 41 and the door sensor 44, and an operating unit 49 for setting a temperature, and compares the received signals with data recorded in a storage unit 46.

The controller 42 has internal software for controlling and operating the present vending machine. The controller controls and operates the supply blower 32, the suction blower 23, the mixing blower 43, the compressor 24, or the heater 45 based on the comparison result obtained by using the internal software, and adjusts the temperature in the storage chamber 12 within a predetermined temperature range in accordance with the supercooled temperature of the canned beverage C.

When the temperature of the storage chamber 12 is in the supercooled temperature range of the canned beverage C, the controller 42 controls and operates the mixing blower 43 or the heater 45, thereby maintaining the temperature to prevent the temperature from being rapidly changed. The air flow rates of the mixing blower 43 and the supply blower 32 are closely associated with an operation of controlling the temperature in the storage chamber 12, and a description thereof will be described in detail below.

As described above, the mixed cool air is supplied to the storage chamber 12 through the holes 33 of the supply duct 31, and supercools the canned beverages C placed on the respective racks 16 in the storage chamber 12. Further, the mixed cool air moves downward toward the lower side of the storage chamber 12 and then is suctioned into the cooling duct 22 by the operation of the suction blower 23 installed in the cooling duct 22. The air suctioned into the cooling duct 22 is cooled while passing through the evaporator 21, and the cool air is mixed with the air in the storage chamber 12, which is again suctioned into the supply duct 31 by the operation of the mixing blower 43. The mixed cool air is again supplied to the storage chamber 12 through the holes 33 of the supply duct 31 in order to cool the canned beverages C. The present vending machine cools the canned beverages C by circulating air, and adjusts the temperature of the cool air using the cool air controlling unit 40 during this process, thereby more easily and assuredly keeping the canned beverage C supercooled.

In addition, the cool air controlling unit 40 may further include one or more heat pipes 47 which extend in the vertical direction inside the supply duct 31 and are disposed at a predetermined interval in the width direction of the storage chamber 12.

The heat pipes 47 include a sealed container which is filled with a working fluid which is changed between a gaseous phase and a liquid phase, and quickly transfers heat between both ends of the container by the phase change of the working fluid. The heat pipe 47 is installed on the inner surface of the supply duct 31, and minimizes a decrease in temperature of the mixed cool air while the mixed cool air moves in the vertical direction of the supply duct 31, thereby uniformly maintaining the temperature of the mixed cool air. Therefore, a change in temperature of the mixed cool air is minimized in the supply duct 31. Therefore, the temperature of the cool air discharged to the respective racks 16 through the respective holes 33 is uniform overall in the longitudinal direction of the supply duct 31, and an overall change in temperature in the storage chamber 12 is also minimized.

Meanwhile, in order to provide a user with the canned beverage selected by a cost process, the vending machine 100 includes a cost processing unit 52 which is disposed at one side of a front surface of the main body 10, for example, at a portion outside the front window, and is used to confirm a cost process associated with the canned beverage, a selection display unit 54 which is used to select the beverage, and an outlet 56 from which the beverage is dispensed.

Therefore, when the user inserts coins or the like into a coin slot installed in the front surface of the main body and selects the beverage, the dispensing unit 70 is operated by receiving signals from the cost process unit 52 and the selection display unit 54. Therefore, the corresponding canned beverage C accommodated on the rack 16 in the storage chamber 12 is moved toward the outlet 56 by the dispensing unit, and is then provided to the user. The canned beverages C are placed in a supercooled state on the racks 16, and the dispensing unit 70 moves the canned beverage from the rack to the outlet 56 while keeping the canned beverage supercooled without applying impact to the canned beverage C. Accordingly, the canned beverage maintained in a supercooled state may be provided to the customer. A structure of the dispensing unit for implementing the aforementioned configuration will be described below again.

The racks 16 on which the canned beverages C are placed are installed in the storage chamber 12 in the main body 10 so as to extend in an up and down direction. Here, the up and down direction means a direction perpendicular to the ground when the vending machine 100 is placed on the ground, that is, a y-axis direction in FIG. 1. In addition, left and right directions in the following description mean both lateral directions of the main body, that is, an x-axis direction in FIG. 1. In addition, forward and rearward directions mean directions toward the front side and the rear side of the main body, that is, a z-axis direction in FIG. 2.

In the present exemplary embodiment, the racks 16 are portions on which the canned beverages C are accommodated and arranged, and include a plurality of shelves 17 which are installed in the storage chamber 12 at predetermined intervals in the vertical direction, and moving units which are installed on the shelves 17 and move the beverages forward. The shelf 17 has holes 18 formed in a bottom surface thereof to allow the cool air to flow therethrough. The shelf 17 extends toward both inner ends in the left and right directions of the storage chamber 12, and is installed horizontally. Partition walls 15, which separate the beverages in the left and right directions, are installed on the shelves 17 at predetermined intervals, and the partition walls 15 extend in the forward and rearward directions along the shelf 17. The moving unit is installed at the upper side of the shelf 17 which is separated by the partition wall 15. The canned beverages C are placed on the respective moving units separated by the partition walls 15, and are moved in the forward and rearward directions by the operation of the moving unit as necessary. For example, in order to distinguish regions of each of the shelves 17, which are separated by the partition walls 15, numbers may be displayed in the regions. Accordingly, by selecting the number of each of region, the customer may easily select the canned beverage C placed in the corresponding region.

As illustrated in FIG. 2, the moving unit includes a conveyor belt 60 which is installed on the bottom surface of the shelf 17 in the forward and rearward directions and on which the canned beverages C are placed, and a drive motor 61 which is connected to a driving roller of the conveyor belt 60 and rotates the conveyor belt 60. The conveyor belt 60 is coupled to a driven sprocket wheel 62 and a driving sprocket wheel 63, which are positioned at the front side and the rear side of the shelf 17 and then rotated. The drive motor 61 is connected to the driving sprocket wheel 63, and transfers power. A vertical plate 64, which pushes the canned beverage C, may be further installed on the conveyor belt 60.

In addition, a detecting sensor 19, which detects whether the canned beverage C is present or not, is further installed at a front side of the partition wall 15. The detecting sensor 19 detects whether the canned beverage C is present at a foremost side among the canned beverages C placed on the conveyor belt 60. The detecting sensor 19 is not particularly limited, and as the detecting sensor 19, various types of sensors may be used as long as the detecting sensor may detect the canned beverage C. The drive motor 61 is controlled and operated in response to signals from the detecting sensor 19, thereby restricting the movement of the canned beverage C.

Therefore, when the foremost canned beverage C is withdrawn and the canned beverage C is not detected by the detecting sensor 19, the drive motor 61 is operated in response to output signals from the detecting sensor 19, and operates the conveyor belt 60. Therefore, when the canned beverage C is moved forward and reaches the foremost position, the detecting sensor 19 detects the canned beverage C, and the drive motor 61 is shut down in response to the output signal. Here, the foremost position means a foremost position of the rack 16, that is, a position at which the dispensing unit 70 may withdraw the canned beverage C.

As described above, the rack 16 stores the canned beverages C thereon, and when the corresponding canned beverage C is withdrawn by the operation of the dispensing unit 70, the rack 16 moves the stored canned beverage C forward, and moves the canned beverage C to the foremost position at which the canned beverage C may be withdrawn. By the aforementioned repeated operations, the canned beverage C placed on each of the racks 16 may be continuously placed at the foremost position.

The dispensing unit 70 withdraws the canned beverage C in a supercooled state from the foremost position of the rack 16, and stably moves the canned beverage C in a supercooled state to the outlet 56 of the main body, at which the customer may hold the canned beverage C, without impact.

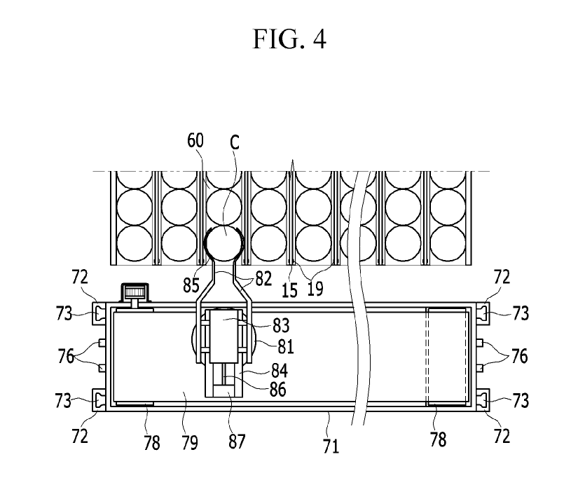

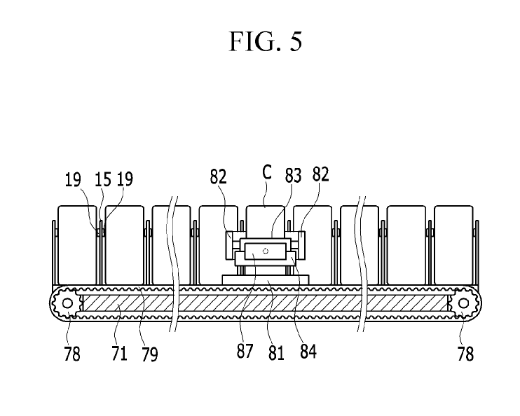

FIGS. 4 and 5 illustrate a structure of the dispensing unit.

As illustrated in FIGS. 4 and 5, the dispensing unit 70 includes a lifting member 71 which is installed between the front window 14 of the main body 10 and the shelves 17 so as to be vertically moved, an up-and-down drive unit which moves the lifting member 71 upward and downward, a clamp which is installed on the lifting member 71 and clamps the canned beverage C placed on the shelf 17, a rotating unit 81 which rotates the clamp, and a left-and-right drive unit which moves the clamp to the left and right sides of the main body 10 along the lifting member 71.

In the main body 10, the front window 14 and the shelves 17 in the storage chamber 12 are spaced apart from each other such that a sufficient space 13 is formed, and the dispensing unit 70 is disposed in the space 13.

Accordingly, the dispensing unit 70 moves the lifting member 71 in the up and down directions inside the space, and moves the clamp in the left and right directions relative to the lifting member 71, thereby moving the clamp to a desired position.

The up-and-down drive unit, which serves to move the lifting member 71 in the up and down directions, includes guide rails 72 which are installed on the main body 10 in the vertical direction, guide bars 73 which are installed on the lifting member 71, coupled to the guide rails 72, and moved along the guide rails 72, a driven sprocket wheel 74 and a driving sprocket wheel 75 which are installed at the upper and lower sides of the main body 10, a chain 76 which is fastened to the driving sprocket wheel and the driven sprocket wheel and has a tip connected to the lifting member 71, and a drive motor 77 which operates the driving sprocket wheel 75.

The guide rails 72 are installed at four corners of the space in which the dispensing unit 70 is installed, and are coupled to the guide bars 73 that are installed at four corners of the lifting member 71.

As illustrated in FIG. 2, the chain 76 is disposed between the guide rails 72, and is connected with the driven sprocket wheel and the driving sprocket wheel which are disposed at the upper and lower sides, such that both tips of the chain 76 are connected to upper and lower ends of the lifting member 71, respectively. The drive motor 77 is connected to the driving sprocket wheel 75 installed at the lower end of the main body 10, and transfers power to the driving sprocket wheel 75. Accordingly, when the driving sprocket wheel 75 is rotated by an operation of the drive motor 77 and the chain 76 is rotated, the lifting member 71 connected to the chain 76 is moved downward or upward.

The left-and-right drive unit includes a pair of rollers 78 which are installed at both lateral ends of the lifting member 71, a conveyor belt 79 which is moved while being connected with the rollers 78, and has an upper surface on which the rotating unit 81 is installed, and an operating motor 80 which rotates the rollers 78. In the present exemplary embodiment, the conveyor belt 79 is installed so that the conveyor belt 79 is connected with the rollers 78, and passes through upper and lower portions of the lifting member 71.

The rotating unit 81 is installed on the conveyor belt 79, and the clamp is coupled on the rotating unit 81. The rotating unit 81 horizontally rotates the clamp, and changes the direction of the clamp. The rotating unit 81 may have a structure that uses rotational motion of a motor, or that converts rectilinear motion of a cylinder into torque, but is not particularly limited thereto. Based on the operation of the rotating unit 81, the direction of the clamp is changed so that the clamp is directed toward the canned beverage C, or directed toward the outlet 56 of the main body 10.

The clamp includes a pair of clamping bars 82 which are elongated and hold the canned beverage C, a drive block 83 which has both lateral sides at which the clamping bars 82 are installed and operates the clamping bars 82, a base member 84 which is coupled to the rotating unit 81 and has an upper end at which the drive block 83 is movably installed, and a drive unit which moves the drive block 83 relative to the base member 84.

The clamping bars 82 are coupled to the drive block 83, and are elongated from the drive block 83 in the horizontal direction. Inner surfaces of tips of the clamping bars 82, which face each other, may be curvedly formed in a circular-arc shape in order to allow the clamping bars 82 to easily hold the canned beverage C. In addition, friction members 85, which increase frictional force with the canned beverage C and prevent the canned beverage C from sliding, may be further installed at the tips of the clamping bars 82.

For example, the drive block 83 spreads the clamping bars 82 or retracts the clamping bars 82 inward using pneumatic pressure or the motor. The drive block 83 is slidably installed on the base member 84. Therefore, the drive block 83 is rectilinearly moved relative to the base member 84 by the operation of the drive unit, and moves the clamping bar 82 forward or rearward. For example, the drive unit may include a conveying screw 86 which extends along the base member 84 and is coupled to the drive block 83, and a step motor 87 which rotates the conveying screw in forward and reverse directions. When the step motor 87 is operated and the conveying screw 86 is rotated in the forward and reverse directions, the drive block 83 thread-coupled to the conveying screw is moved forward or rearward along the base member 84.

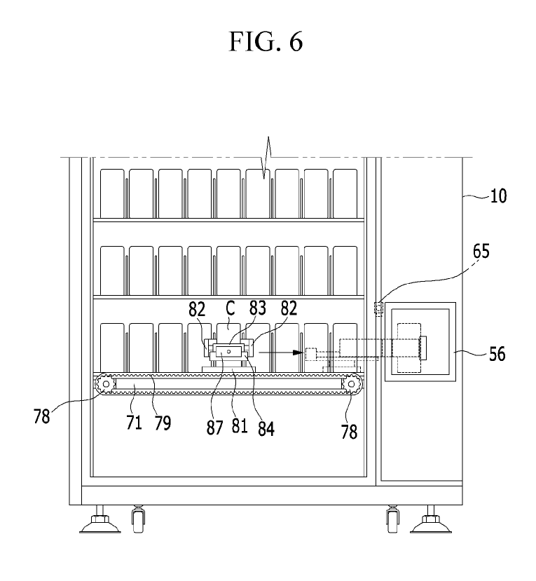

An operation of the dispensing unit will be described below with reference to FIGS. 6 and 7.

When a customer pays a cost and selects a desired canned beverage C, the dispensing unit 70 is operated to move the corresponding canned beverage C placed on the rack 16 to the outlet 56 of the main body 10. Therefore, the customer may obtain the desired canned beverage C through the outlet 56. In this process, the dispensing unit 70 minimizes impact applied to the canned beverage C, thereby consistently keeping the canned beverage C supercooled.

The clamp, which clamps the canned beverage C, is moved from a predetermined initial position and is then positioned in front of the canned beverage C placed on the corresponding rack 16 by the movement of the lifting member 71 and the conveyor belt 79.

When the drive motor 77 is operated, the driving sprocket wheel 75 is rotated, and the chain 76 is moved. Accordingly, the lifting member 71 coupled to the chain 76 is pulled upward or downward, and is moved along the guide rails 72 in the up and down directions. Therefore, the lifting member 71 moves the clamp to a position of the shelf 17 on which the corresponding canned beverage C is placed among the plurality of shelves 17.

Further, the operating motor 80 installed on the lifting member 71 is operated, and moves the clamp in the left and right directions of the lifting member 71, thereby moving the clamp to a position of the shelf 17 on which the desired canned beverage C is placed. When the operating motor 80 is operated, the rollers 78 are rotated, and the conveyor belt 79 installed to the roller 78 is rotated, thereby horizontally moving the clamp installed on the conveyor belt 79 to a desired position. As described above, the clamp is positioned in front of the desired canned beverage C by the processes of moving the clamp in the up and down directions and in the left and right directions.

Here, the clamping bars 82 of the clamp are maximally spread outward in a state in which the clamp is directed toward the canned beverage C. In this state, when the step motor 87 installed on the base member 84 is operated, the drive block 83 is moved forward along the conveying screw, and moved toward the shelf. Accordingly, the pair of clamping bars 82 installed on the drive block 83 are moved to both lateral sides of the canned beverage C. When the drive block 83 is completely moved forward, the drive block 83 is operated to retract the clamping bars 82, which have been spread outward, to be retracted inward, and the clamping bars 82 hold the canned beverage C. Accordingly, the canned beverage C is pressed and clamped by the clamping bars 82. When the canned beverage C is fixed to the clamping bar 82, the step motor 87 is operated to move the drive block 83 rearward. When the drive block 83 is moved rearward, the canned beverage C is withdrawn from the foremost position of the shelf 17 in a state in which the canned beverage C is fixed to the clamping bar 82.

When the canned beverage C at the foremost position is withdrawn, the canned beverage C is not detected by the detecting sensor 19 installed on the partition wall 15. Accordingly, the drive motor 61 is operated in response to the signal from the detecting sensor 19, such that the canned beverage C placed on the conveyor belt 60 is moved. Therefore, the canned beverage C is positioned at the foremost position, such that the canned beverage C may be on standby in a state in which the canned beverage C may be continuously withdrawn.

The directions of the clamping bars 82 to which the canned beverage C is fixed are changed by the operation of the rotating unit 81, thereby allowing the canned beverage C to be directed toward the outlet. That is, the clamping bars 82 clamp the canned beverage C in a state in which the clamping bars 82 are disposed in the forward and rearward directions, and then are rotated 90 degrees by the rotating unit 81 so as to be disposed in the left and right directions. When the clamp is rotated, the lifting member 71 is moved upward and downward by the operation of the drive motor 77, and positions the clamping bars 82 at a height corresponding to a height of the outlet 56.

Further, the operating motor 80 is operated to move the conveyor belt 79, such that the clamping bars 82 are moved toward the outlet along the lifting member 71 in a state in which the clamping bars 82 hold the canned beverage C.

Here, a dispensing box 57, which has a horizontal bottom surface 58, is formed in the outlet 56 so that the canned beverage C conveyed by the clamping bars 82 is stably placed. Accordingly, the clamping bars 82 enter the dispensing box 57 by the operation of the dispensing unit 70 as described above, such that the canned beverage C, which is conveyed while being held by the clamping bars 82, is finally positioned in the dispensing box 57. In this state, when the drive block 83 is operated and the clamping bars 82 are spread outward, the canned beverage C is released from the clamping bars 82, and then placed on the bottom surface 58 of the dispensing box 57. The bottom surface 58 of the dispensing box 57 is formed at a height corresponding to a height of a lower end of the canned beverage C that is held by the clamping bars 82, such that the canned beverage C is positioned to be roughly adjacent to the bottom surface 58 of the dispensing box 57. Therefore, even though the clamping bars 82 are spread outward to release the canned beverage C, the canned beverage C may be placed on the bottom surface 58 of the dispensing box 57 without great impact.

When the canned beverage C is placed on the bottom surface 58 of the dispensing box 57, the dispensing unit 70 returns to the standby state.

Therefore, the customer may obtain the desired canned beverage C through the outlet 56.

The outlet 56 and the dispensing box 57 are in communication with the storage chamber 12 during a process of conveying the canned beverage C, and as a result, it is necessary to minimize an amount of cool air which escapes from the interior of the storage chamber 12 through the outlet 56 of the dispensing box 57. Accordingly, an outlet door 53, which opens and closes the outlet 56, is installed at the outlet 56. In addition, an inlet 55 is formed at a side surface inside the dispensing box 57 so as to allow the canned beverage C held by the clamping bar 82 to enter the inlet 55, and a blocking shutter 59, which selectively blocks the inlet 55, is installed at the inlet 55. As illustrated in FIG. 7, the blocking shutter 59 has a structure in which a middle portion is cut, and both tip portions are rotatably installed at the inlet 55, respectively. The blocking shutter 59 is installed at the inlet 55 so as to be elastically restored by an elastic member such as a spring. Accordingly, when the canned beverage C held by the clamping bars 82 enters the inlet 55, the blocking shutter 59 is pushed by the clamping bars 82 such that the middle portion of the blocking shutter 59 is opened while being spread, and when the clamping bars 82 are moved rearward away from the blocking shutter 59, the blocking shutter 59 elastically returns to an original position, and blocks the inlet 55.

In addition, an air fan 65, which forms an air curtain by discharging air downward, is further installed at an upper end of the inlet 55 independent of the blocking shutter. The air fan 65 is installed to extend along the upper end of the inlet, and discharges air through a nozzle that is formed in a slit shape formed downward. Accordingly, an air film in the form of a curtain is formed at the inlet by air discharged from the air fan 65, thereby preventing the cool air from being discharged to the outside through the inlet 55.

In the present exemplary embodiment, the air fan 65 is operated when the blocking shutter 59 is opened, and blocks the opened inlet using air. Accordingly, it is possible to prevent the cool air in the storage chamber 12 from being discharged through the opened blocking shutter, and preserve the cool air. The operation of the air fan 65 continues until the operation of dispensing the canned beverage is completed by the dispensing unit, and then the blocking shutter 59 is closed and the operation of the air fan is stopped when the blocking shutter is closed.

As described above, the canned beverages C are stored on the racks in the storage chamber 12, and preserved in a supercooled state in which the beverages are not frozen at a temperature below a freezing point. The canned beverage C in a supercooled state is stably provided to the customer from the vending machine 100 using the dispensing unit without impact. Thereafter, when the customer applies external impact to the canned beverage C, the liquid beverage in the canned beverage C is instantaneously frozen to be in a slurry state.

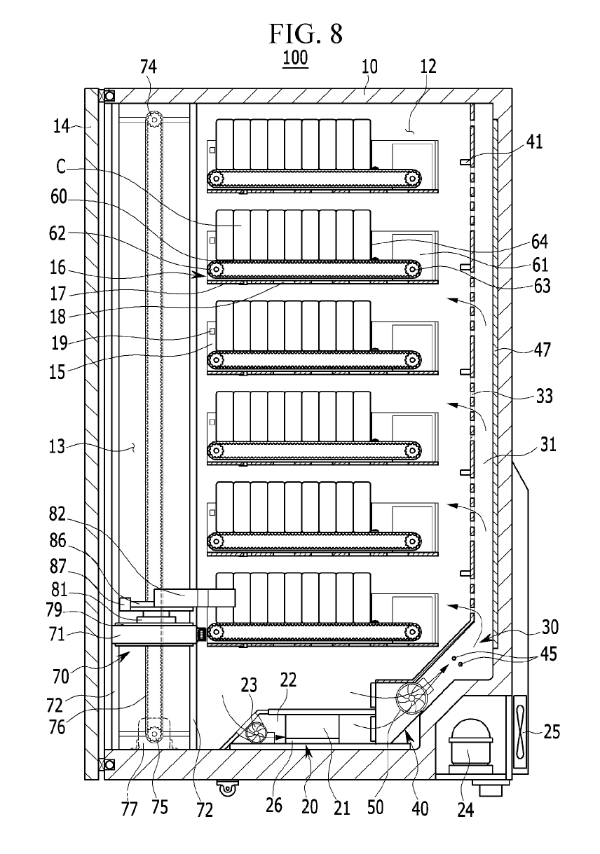

FIG. 8 illustrates another exemplary embodiment of the present apparatus.

Hereinafter, in the exemplary embodiment, the present vending machine has the same structure as the vending machine described above in terms of other components except for the structure of the mixing unit of the cool air controlling unit 40. Therefore, like reference numerals refer to like elements, and a detailed description thereof will be omitted.

As illustrated in FIG. 8, in the present exemplary embodiment, the mixing unit has a structure in which the lower end of the supply duct 31 is installed to simultaneously face the storage chamber 12 and the cooling duct 22, a supply blower 50 is installed in the discharge port of the cooling duct 22, and the supply blower 50 is installed to simultaneously face the storage chamber 12 and the cooling duct 22, such that both of the cool air in the cooling duct 22 and the air in the storage chamber 12 are sent into the supply duct 31. Herein, the term “simultaneously face” means that the suction port provided in the supply blower 50 is connected with both of the cooling duct 22 and the storage chamber 12. In addition, the discharge port of the supply blower 50 is connected with the supply duct 31.

In the present exemplary embodiment, a part of the air in the storage chamber 12 may be mixed with the cool air in the cooling duct 22 by only using the supply blower 50.

Therefore, the cool air, which is cooled while passing through the cooling duct 22, is discharged into the supply duct 31 using the supply blower 50, and a part of the air in the storage chamber 12 is also suctioned into the supply duct 31 using the supply blower 50. Therefore, the cool air passing through the evaporator 21 and the air in the storage chamber 12 are mixed in the supply duct 31, and the mixed cool air is supplied into the storage chamber 12 through the supply duct 31.

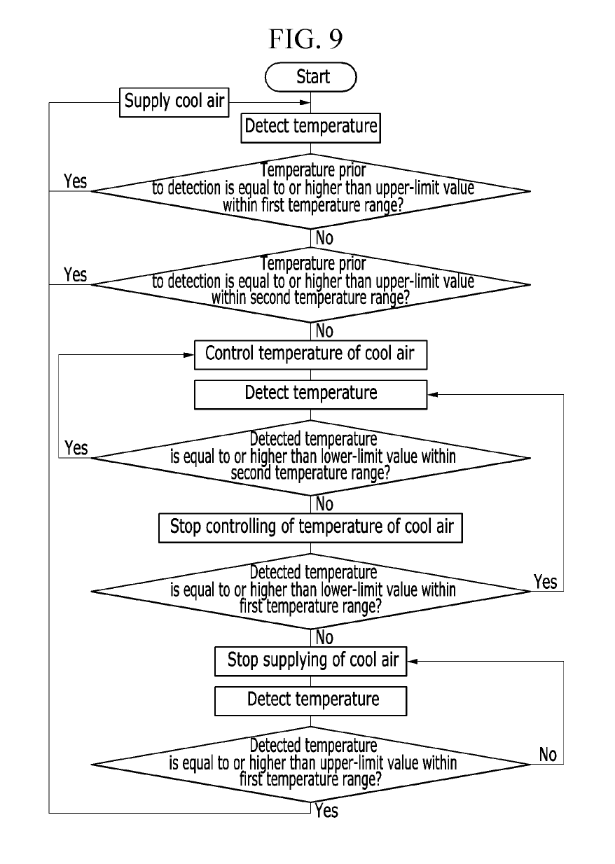

Hereinafter, a process of controlling a temperature of the vending machine according to the present exemplary embodiment will be described below with reference to FIG. 9. Hereinafter, a process of controlling a temperature of the vending machine will be described with reference to the vending machine according to the exemplary embodiment illustrated in FIG. 1 as an example.

When the present vending machine 100 is operated, the temperature in the storage chamber 12 is detected by the temperature sensor 41. A temperature value detected by the temperature sensor 41 is transferred to the controller 42. First, the controller 42 compares a detected value of an actual temperature in the storage chamber 12 with a set temperature value set in the storage unit 46.

A temperature range for controlling the supercooled temperature of various beverages, including a set temperature value of the canned beverage C, is recorded in the storage unit 46 as a set temperature value. The set temperature value is changed as necessary in accordance with the corresponding beverage by the operating unit 49 connected to the controller 42. For example, the operating unit 49 may have a structure in which buttons, which are classified by the type of beverages, are disposed. Accordingly, by a single operation of pressing the button corresponding to the beverage, the temperature range may be simply changed in accordance with the corresponding beverage.

In the present exemplary embodiment, the temperature range stored in the storage unit 46 is classified into a first temperature range for determining whether to supply the cool air and a second temperature range for controlling the temperature of the cool air. The controller 42 supplies the cool air or stops the supplying of the cool air when the corresponding temperature range deviates from the first temperature range. In the second temperature range, the controller 42 controls the temperature of the cool air supplied to the storage chamber 12 so that the temperature in the storage chamber 12 is not rapidly decreased due to the supply of the cool air.

The first temperature range is set to a temperature range for keeping the canned beverage C supercooled. The first temperature range is set by the aforementioned step of adjusting the set temperature value in accordance with the corresponding canned beverage by controlling the operating unit.

In the present exemplary embodiment, the first temperature range is set to a range of −3° C. to −15° C. which is the supercooled temperature range for the canned beverage. The second temperature range is set to be within the first temperature range. For example, the second temperature range may be set to a range of 80% of the first temperature range. That is, when the first temperature range is from −3° C. to −15° C., the second temperature range is set from −4.2° C. to 13.8° C.

The controller 42 compares a temperature value, which is detected by operating software provided in the controller 42, with the predetermined first temperature range, and supplies the cool air to the storage chamber 12 when the detected temperature is equal to or higher than an upper-limit value within the first temperature range. When the suction blower 23 is operated in response to a control signal from the controller 42, the air in the storage chamber 12 is suctioned into the cooling duct 22. In addition, when the compressor 24 is operated, heat exchange is carried out by the evaporator 21, and as a result, the cool air is created. The cool air is discharged into the supply duct 31 by the operation of the supply blower 32 installed at an outlet side of the cooling duct 22. The cool air supplied to the supply duct 31 is discharged into the storage chamber 12 through the holes 33 formed in the supply duct 31 while flowing upward along the supply duct 31, and decreases the temperature in the storage chamber 12 in the supercooled temperature range of the canned beverage C. Accordingly, the canned beverages C placed on the rack 16 are supercooled in the storage chamber 12.

The controller 42 consistently detects the temperature in the storage chamber 12, and compares whether the detected temperature is lower than an upper-limit value within the second temperature range. When the detected temperature is equal to or higher than the upper-limit value within the second temperature range, the process is consistently repeated, and when the detected temperature is lower than the upper-limit value within the second temperature range, the controller 42 controls the temperature of the cool air.

The process of controlling the temperature of the cool air is carried out by controlling an air flow rate in accordance with the operations of the supply blower 32 and the mixing blower 43, or by operating the heater 45.

When the controller 42 operates the heater 45, the temperature of the cool air is increased while the cool air sent to the supply duct 31 passes through the heater 45 installed in the supply duct 31. Therefore, the cool air of which the temperature is increased by the heater 45 is supplied into the storage chamber 12. As the cool air is supplied to the storage chamber 12 by increasing the temperature of the cool air by controlling the heater 45, the temperature in the storage chamber 12 is not rapidly decreased but is gradually decreased. Accordingly, the supercooled temperature for the canned beverage may be more consistently and stably maintained. Moreover, a time interval between operating and stopping of the compressor 24 for supplying the cool air is increased, and as a result, it is possible to minimize a failure caused by frequent on/off operations of the compressor 24, and prevent frost from being created in the evaporator.

The controller 42 operates the mixing blower 43 in addition to the operation of the heater 45, and controls the temperature of the cool air. When the mixing blower is operated, a part of the air in the storage chamber 12 does not pass through the cooling duct 22, but is directly suctioned into the supply duct 31 by the mixing blower 43. In a state in which the cool air passing through the cooling duct 22 is supplied to the supply duct 31, the air in the storage chamber 12, which is not cooled as described above and thus has a higher temperature than the cool air, is supplied to the supply duct 31, and as a result, the cool air and the air in the storage chamber 12 are mixed in the supply duct 31. Therefore, the cool air is mixed with the air having a high temperature, and as a result, the temperature of the cool air is increased. Accordingly, the mixed air, of which the temperature is increased compared to the cool air, is supplied into the storage chamber 12. As the cool air is supplied to the storage chamber 12 after increasing the temperature of the cool air using the operation of the mixing blower 43, the supercooled temperature for the canned beverage C may be more consistently and stably maintained without a rapid change in temperature.

Herein, the controller 42 controls the air flow rate of the mixing blower 43 and the air flow rate of the supply blower 32, thereby more precisely controlling the temperature of the mixed cool air. For example, when the temperature of the cool air is intended to be more gradually changed, the controller 42 causes the air flow rate of the mixing blower 43 to be higher than the air flow rate of the supply blower 32, thereby increasing an amount of the air mixed with the cool air. Therefore, the amount of the air is greater than the amount of the cool air sent to the supply duct 31, thereby further increasing the temperature of the mixed cool air. The temperature of the mixed cool air is precisely controlled by controlling the air flow rates of the cool air and the air, thereby more gradually changing the temperature in the storage chamber 12 and more consistently maintaining the temperature in the storage chamber 12.

Meanwhile, the controller 42 checks whether the temperature in the storage chamber 12 detected by the aforementioned process of controlling the temperature of the cool air deviates from a lower-limit value within the second temperature range. The controller 42 stops the operation of controlling the temperature of the cool air when the detected temperature deviates from the lower-limit value within the second temperature range. As the operation of controlling the temperature of the cool air is stopped, low-temperature cool air is just supplied to the storage chamber 12. Therefore, the temperature in the storage chamber 12 is rapidly decreased, and the controller 42 checks whether the detected temperature deviates from a lower-limit value within the first temperature range, and stops the supplying of the cool air when the detected temperature deviates from the lower-limit value within the first temperature range.

The controller 42 stops the operations of the compressor 24 and the respective blowers, thereby cutting off supply of the cool air to the storage chamber 12.

While the supply of the cool air is stopped, the temperature in the storage chamber 12 is gradually increased. The controller 42 consistently detects the temperature in the storage chamber 12 using the temperature sensor 41. The controller 42 compares the detected temperature in the storage chamber 12 with the first temperature range, and when the temperature value is increased to be equal to or higher than the upper-limit value within the first temperature range, the controller 42 allows the cool air to be supplied again.

The temperature in the storage chamber 12 may be stably maintained in accordance with a supercooled temperature condition for the canned beverage C by controlling the temperature of the cool air as described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10: Main body | 12: Storage chamber |
| 13: Space | 14: Front window |
| 15: Partition wall | 16: Rack |
| 17: Shelf | 19: Detecting sensor |
| 20: Cooling unit | 21: Evaporator |
| 22: Cooling duct | 23: Suction blower |
| 24: Compressor | 25: Condenser |
| 30: Cool air supplying unit | 31: Supply duct |
| 32: Supply blower | 33: Hole |
| 40: Cool air controlling unit | 41: Temperature sensor |
| 42: Controller | 43: Mixing blower |
| 44: Door sensor | 45: Heater |
| 47: Heat pipe | 48: Blocking member |
| 50: Supply blower | 53: Outlet door |
| 56: Outlet | 57: Dispensing box |
| 58: Bottom surface | 59: Blocking shutter |
| 60: Conveyor belt | 61, 77: Drive motor |
| 62, 74: Driven sprocket wheel | 63, 75: Driving sprocket wheel |
| 64: Vertical plate | 65: Air fan |
| 70: Dispensing unit | 71: Lifting member |
| 72: Guide rail | 76: Chain |
| 78: Roller | 79: Conveyer belt |
| 80: Operating motor | 81: Rotating unit |
| 82: Clamping bar | 83: Drive block |
| 84: Base member | 86: Conveying screw |
| 87: Step motor | |

1. A vending machine which sells beverages, the vending machine comprising:
a main body which has a storage chamber that accommodates beverages and stores the beverages in a supercooled state;
racks which are disposed in the storage chamber and on which the beverages are placed;
a cooling unit which cools air in the storage chamber;
a cool air supplying unit which circulates air cooled by the cooling unit into the storage chamber;
a cool air controlling unit which controls a temperature of cool air supplied from the cool air supplying unit in a supercooled temperature range of the canned beverage; and
a dispensing unit which withdraws the beverage placed on the rack while keeping the beverage supercooled, and moves the beverage to an outlet of the main body.

2. The vending machine of claim 1, wherein the cooling unit includes:
an evaporator which is installed at a lower end of the main body and cools air using heat exchange;
a cooling duct in which the evaporator is installed and which connects the interior of the storage chamber with the cool air supplying unit;
a suction blower which is installed at one side of the cooling duct and suctions air in the storage chamber; and
a compressor and a condenser which circulate a refrigerant into the evaporator.

3. The vending machine of claim 2, wherein the cool air supplying unit includes:
a supply duct which extends upward along an inner surface of the storage chamber;
a supply blower which is installed at a lower end of the supply duct connected with the cooling duct, and sends the cool air to the supply duct; and
a plurality of holes which are formed in a front surface of the supply duct, and discharge the cool air.

4. The vending machine of claim 3, wherein the cool air controlling unit includes:
a mixing unit which supplies the air in the storage chamber to the cool air supplying unit and mixes the supplied air with cool air as necessary;
a temperature sensor which is installed in the supply duct and detects a temperature at the storage chamber; and
a controller which calculates values detected by the temperature sensor and controls the cooling unit, the cool air supplying unit, and the mixing unit so that the temperature in the storage chamber is in a predetermined temperature range.

5-7. (canceled)

8. The vending machine of claim 4, wherein the mixing unit includes a mixing blower which is installed between the lower end of the supply duct and the storage chamber, and sends the air in the storage chamber to the supply duct.

9. The vending machine of claim 4, wherein the mixing unit has a structure in which the lower end of the supply duct is installed to simultaneously face the storage chamber and the cooling duct, and the supply blower is installed so that a suction port thereof simultaneously faces the storage chamber and the cooling duct such that the cool air in the cooling duct and the air in the storage chamber are sent into the supply duct.

10. The vending machine of claim 1, wherein the dispensing unit includes:
a lifting member which is installed between the front window of the main body and the shelves so as to be vertically moved;
an up-and-down drive unit which moves the lifting member upward and downward;
a clamp which is installed on the lifting member and clamps the beverage placed on the shelf;
a rotating unit which rotates the clamp; and
a left-and-right drive unit which moves the clamp to the left and right sides of the main body along the lifting member.

11. The vending machine of claim 10, wherein the clamp includes:
a pair of clamping bars which are elongated and hold the beverage;
a drive block which has both lateral sides at which the clamping bars are installed, and operates the clamping bars;
a base member which is coupled to the rotating unit and has an upper end at which the drive block is movably installed; and
a drive unit which moves the drive block relative to the base member.

12. The vending machine of claim 11, wherein the up-and-down drive unit includes:
guide rails which are installed on the main body in the vertical direction;
guide bars which are installed on the lifting member, coupled to the guide rails, and moved along the guide rails;
sprocket wheels which are installed at the upper and lower sides of the main body;
a chain which is fastened to the sprocket wheels and has a tip connected to the lifting member; and
a drive motor which operates the sprocket wheels.

13. The vending machine of claim 12, wherein the left-and-right drive unit includes:
a pair of rollers which are installed at both lateral ends of the lifting member;
a conveyor belt which is rotated while being connected with the rollers and on which the rotating unit is installed; and
an operating motor which rotates the rollers.

14. The vending machine of claim 10, wherein the dispensing unit further includes:
a dispensing box which is formed in the outlet and has a horizontal bottom surface on which the beverage is placed;
an outlet door which opens and closes the outlet;
an inlet which is formed at a side surface inside the dispensing box and allows the beverage held by the clamping bars to enter the inlet; and
a blocking shutter which is installed at the inlet and selectively blocks the inlet.

15. The vending machine of claim 14, wherein the dispensing unit further includes an air fan which is installed above the blocking shutter and forms an air curtain by discharging air downward.

16. The vending machine of claim 10, wherein the racks include:
a plurality of shelves which are installed in the storage chamber at predetermined intervals in a vertical direction; and
moving units which are installed on the shelves and move the beverages forward.

17. The vending machine of claim 16, wherein the moving unit includes:
a conveyor belt which is installed on the bottom surface of the shelf in the forward and rearward directions and on which the beverages are placed; and
a drive motor which is connected to a driving roller of the conveyor belt and rotates the conveyor belt.

18. The vending machine of claim 17, wherein partition walls, which separate the beverages in a lateral direction, are installed on the shelves at predetermined intervals, and the moving unit is installed between the partition walls.

19. (canceled)

20. A method of controlling a beverage vending machine which stores beverages in a supercooled state in a storage chamber, the method comprising:
detecting a temperature in the storage chamber of the beverage vending machine;
comparing the detected temperature value with an upper-limit value within a predetermined first temperature range;
supplying cool air into the storage chamber when the detected temperature value is equal to or higher than the upper-limit value within the first temperature range;
comparing the detected temperature value with an upper-limit value within a second temperature range when the detected temperature value is lower than the upper-limit value within the first temperature range;
controlling a temperature of cool air supplied into the storage chamber when the detected temperature value is lower than the upper-limit value within the second temperature range;
stopping the controlling of the temperature of the cool air when the temperature in the storage chamber is detected and the detected temperature value is equal to or lower than a lower-limit value within the second temperature range;
comparing the detected temperature value with a lower-limit value within the first temperature range;
stopping the supplying of the cool air when the detected temperature value is equal to or lower than the lower-limit value within the first temperature range; and
consistently stopping the supplying of the cool air when the temperature in the storage chamber is detected and the detected temperature is lower than the upper-limit value within the first temperature range, and supplying the cool air into the storage chamber when the detected temperature is equal to or higher than the upper-limit value within the first temperature range.

21. The method of claim 20, wherein the second temperature range is within the first temperature range.

22. The method of claim 21, wherein the controlling of the temperature of the cool air includes mixing the air in the storage chamber with the cool air supplied to the storage chamber.

23. The method of claim 21, wherein the controlling of the temperature of the cool air includes controlling a ratio between a supply amount of cool air supplied to the storage chamber and a supply amount of air in the storage chamber which is mixed with the cool air.

24. (canceled)

25. The method of claim 20, further comprising
adjusting the first temperature range in accordance with the type of beverages stored in the storage chamber of the beverage vending machine,
wherein the adjusting of the first temperature range is performed by a single operation of manipulating buttons that are classified by the type of beverages.
